(19) United States
(12) Patent Application Publication
(10) Pub. No.: US 2007/0185222 A1
(43) Pub. Date: Aug. 9, 2007

(54) Lightweight polypropylene nets manufactured with a beta nucleation additive, the method of manufacture and uses thereof

(76) Inventor: William Shelton, Lithonia, GA (US)

Correspondence Address: JACOBSON HOLMAN PLLC, 400 SEVENTH STREET N.W., SUITE 600, WASHINGTON, DC, 20004, US

(21) Appl. No.: 11/628,240

(22) PCT Filed: Jun. 6, 2005
(86) PCT No.: PCT/US05/19622

§ 371 Date: Dec. 1, 2006

Related U.S. Application Data
(60) Provisional application No. 60/576,811, filed on Jun. 4, 2004.

(51) Int. Cl. B29C 44/34

(52) U.S. Cl. 521/142

(57) ABSTRACT

Integral polypropylene oriented nets are made by stretching and orienting a polypropylene starting sheet material having a defined pattern of holes or depressions in which the polypropylene is at least 20%, and preferably up to about 80%, beta crystals caused by adding a beta nucleating agent to the polypropylene, preferably in concentrations between about 10 ppm to about 100 ppm. Such beta nucleated polypropylene nets exhibit increased yield and break tensile strengths, flexural stiffness, modulus characteristics, and crimping retention and resiliency over substantially identical oriented nets made from polypropylene without a beta nucleating agent added. A method for manufacturing the beta nucleated polypropylene oriented net is disclosed, along with a crimped beta nucleated polypropylene oriented net (16) and a sandwich mat product (10) for erosion control which includes the crimped beta nucleated polypropylene oriented net (16) as a layer therein.

### RELATED APPLICATION

This is a nationalization of PCT/US05/019622, filed Jun. 6, 2005 and published in English, claiming benefit of priority to U.S. provisional patent application Ser. No. 60/576,811, filed Jun. 4, 2004.

### BACKGROUND OF INVENTION

1. Field of Invention

This invention relates to the production of lightweight biaxially oriented polymer nets and relates more particularly to nets made from homopolymer and copolymer polypropylene in which a beta nucleation concentrate has been added to enhance the product physical characteristics, as well as to improve the production rates for orientation of such polymer nets. This invention applies to lightweight nets that are not to be used in a soil reinforcement or stabilization application.

This invention also relates to crimped or corrugated, biaxially oriented mat products incorporating such corrugated nets.

For the purpose of this invention, the terms “lightweight oriented net” and “oriented net” are intended to include integral oriented nets made by biaxially orienting (stretching) starting materials in the form of sheets or the like, which oriented nets have mesh opening sizes ranging from about 3 mm×about 3 mm to about 40 mm×about 40 mm and a mass that ranges from about 4 grams/square meter to about 150 grams/square meter.

2. Description of the Related Art

Lightweight uniaxial and biaxial nets have been manufactured for many years primarily from a tubular cast extrusion process, and are used in many applications from carpet backing, erosion control, filtration support, containment, etc. Such nets may be integrally cast and then stretched using any of a variety of well known techniques such as those described for example in U.S. Pat. No. 2,919,467 to Mercer, U.S. Pat. No. 3,070,840 to Mercer, U.S. Pat. No. 3,252,181 to Hureau, U.S. Pat. No. 3,317,951 to Hureau, U.S. Pat. No. 3,384,530 to Mercer et al., U.S. Pat. No. 3,384,692 to Galt et al., U.S. Pat. No. 3,496,965 to Hureau, U.S. Pat. No. 3,917,889 to Gaffney et al., and U.S. Pat. No. 4,756,946 to Mercer. The subject matters of all of the foregoing identified nine patents are expressly incorporated by reference in this application as if set forth fully herein. These patents are cited as illustrative, and are not considered to be all inclusive, or to exclude other techniques known in the art for the production of oriented integral nets.

The polymeric materials used in the production of such nets heretofore have been produced from homopolymer and copolymer polypropylene and with the addition of variable amounts of additives from none, to colorants, to carbon black, and to ultra-violet light inhibitors. The biaxially oriented nets have been especially beneficial when corrugated or crimped for use in sandwich mat products for erosion control. It would therefore be desirable and advantageous to enhance the break and yield tensile strengths, the flexural stiffness, the modulus characteristics, and the crimping retention and resiliency of biaxially oriented net once it has been processed through a crimping machine, as well as increase the speed of stretching from the current fixed cast starting net thicknesses and defined orientation stretch ratios.

### SUMMARY OF THE INVENTION

The most common crystal form of polypropylene is the alpha crystal which melts at approximately 160° C. for typical Zeigler-Natta polymerized homopolymer or copolymer polypropylene. A less common form, known as the beta or hexagonal crystal form, generally comprises less than 5% of the polypropylene crystals. The beta crystals have a melting point that is typically 12-15° C. below that of the alpha form. It is known that the beta phase of an isotactic polypropylene can improve toughness and impact strengths. Finally, a beta nucleator activated at the appropriate processing temperature during cast sheet extrusion, sharply raises the percentage of beta crystals.

In addition to the melting point differences, the beta crystals produce other physical property changes such as an improvement in tensile strengths, modulus, and flexural stiffness. Also the beta crystals develop microvoids that upon orientation displace or redistribute some polymer mass resulting in a lowered product weight for the desired strengths.

There are known different beta initiators for polypropylene. The most common types known are red dye pigments (e.g. quinacridones). Others are considered non-pigmenting such as a new class developed as a solid white powder by New Japan Chemical designated NJ Star NU-100, which is introduced into polypropylene during processing or compounding. Previously, beta nucleants have been added for processing biaxially oriented polypropylene film (BOPP). This work with BOPP film is disclosed in U.S. Pat. Nos. 5,310,584, 5,594,070, 5,317,035, 5,236,963, 5,176,953, and 4,975,469.

It has now been found that compounding polypropylene with a beta nucleating agent which converts the alpha polypropylene to the beta form, preferably to a level up to 80%, for the polypropylene in the starting sheet material, will result in a final oriented net, which has significantly higher yield and break tensile strengths, flexural stiffness, modulus characteristics, and crimping retention and resiliency, over substantially identical oriented nets made from polypropylene without a beta nucleating agent added. Another way to view the present invention is that the heretofore obtainable finished product yield and break tensile strengths, as well as the flexural stiffness, modulus and crimping characteristics, at all previous starting sheet thicknesses as practiced in the referenced patents, can now be obtained with starting sheet thicknesses and masses that are 5%-25% less than those prior to the practice of the present invention.

It has further been found that the speed of orientation of the beta-enhanced polypropylene starting material can be significantly increased and carried out at the same and lower temperatures over standard polypropylene starting materials, thus significantly reducing the production costs for manufacturing the final oriented nets. This increase in speed can be at least 1.5 times as high as currently practiced, and up to three times as high, or more. Finally, the beta-enhanced polypropylene oriented nets have a significantly lighter weight (lbs/sq.ft.) than conventional polypropylene oriented nets of the same strength and performance characteristics, thus saving on material and shipping costs.

It is believed that conversion of the alpha polypropylene crystals by the beta nucleating agent to as little as 20%-30% of the beta crystalline form in the final starting sheet material can cause the resultant oriented net to exhibit the improved property characteristics and orienting enhancements described herein. However, higher conversion is clearly desirable so that the full benefits of the polypropylene beta crystalline structure result. Hence, the beta nucleating conversion should preferably result in a starting sheet material having up to 80%, or more, polypropylene in the beta crystalline form.

Accordingly, it is an object of the present invention to produce a lightweight oriented net which as cast is capable of being stretched at least one and one-half or two times its original size uniaxially, and preferably up to eight times its original size or more biaxially, in order to provide large sheets of lightweight, thin strand oriented net with substantial open areas from limited quantities of starting material.

It is a further object of the present invention to produce a beta nucleated polypropylene oriented net manufactured in accordance with known process methods having at least 20%-30% of the polypropylene crystals in the beta form, preferably up to about 80%, which will exhibit increased yield and break tensile strengths, increased modulus characteristics, increased flexural stiffness, and improved crimping retention and resiliency.

A further object of this invention is to produce an lightweight oriented net by incorporating an additive that modifies the crystalline structure of the cast polypropylene starting material such that a broader window of processing in the form of lower orientation temperatures is realized and there is a resultant increase in the yield and break tensile strengths, flexural stiffness, and modulus characteristics, at the defined net thicknesses than could be achieved without the addition of this additive.

An additional object of this invention is to increase the rigidity, retention, and resiliency of the polypropylene oriented net once it has been corrugated or crimped by passing through a crimping machine.

Another object of the present invention is to provide an improved sandwich mat product for erosion control and a corrugated or crimped oriented net therefor which exhibits improved rigidity, retention and resiliency.

Yet another object of this invention is that with the addition of the additive, the economics associated with the cost of production will improve based on the additive modifying the crystalline structure of the cast starting material such that the thickness of cast starting material can be reduced by up to 30% from cast starting materials without the additive, yet when stretched and oriented the final oriented nets according to the present invention give tensile strength, modulus and flexural stiffness characteristics equivalent to those obtained from the thicker cast starting materials without the additive.

These and other objects of the invention, as well as many of the intended advantages thereof, will become more readily apparent when reference is made to the following description taken in conjunction with the accompanying drawings, which are for illustration and not intended to be to scale.

### BRIEF DESCRIPTION OF THE DRAWINGS

FIG. 1 shows an exploded partial perspective view of a sandwich mat product containing a corrugated or crimped oriented net made in accordance with the present invention.

FIG. 2 is a schematic side view illustration of the corrugated or crimped oriented net made in accordance with the present invention.

### DETAILED DESCRIPTION OF THE PREFERRED EMBODIMENTS

In describing the preferred embodiments, specific terminology will be resorted to for the sake of clarity. However, the invention is not intended to be limited to the specific terms so selected, and it is to be understood that each specific term includes all technical equivalents which perform in a similar manner to accomplish a similar purpose.

For the present invention, the more common red quinacridone dye nucleating agent is preferably used. The quinacridone dye is often effective at very low levels in the parts per million (ppm) range, and is generally formulated as a polymer concentrate having 2000 ppm, more or less, of the quinacridone dye in a polypropylene carrier.

One supplier of the red quinacridone dye nucleating agent is Standridge Color Corporation (“Standridge”), of Social Circle, Ga. The Standridge beta nucleating concentrate is a concentrated pellet product that contains approximately 2000 ppm of the beta nucleating red quinacridone dye in a polypropylene homopolymer carrier resin. Another supplier of a red quinacridone dye nucleating concentrate is Mayzo, Inc. (“Mayzo”) of Norcross, Ga. The Mayzo beta nucleating agent is identified as BNX BETA PP. It is a concentrated pellet product that is believed to contain 450 ppm, more or less, of the beta nucleating red quinacridone dye in a polypropylene homopolymer carrier resin that has a melt flow index of 4.0 grams/10 mins, more or less. Other manufacturers or suppliers may also provide an equivalent or similar nucleating agent when added to polypropylene resin. Such a product, for example, is designated NJ Star NU-100 and manufactured by a company named New Japan Chemical Company. This beta nucleating agent is a solid white powder, and is introduced into polypropylene during processing or compounding.

These type nucleating agents in pellet concentrate form are preferably blended with the polypropylene used to manufacture the oriented nets at levels of at least about 0.5% to up to about 5% or more. With the concentrate containing 2000 ppm of the beta nucleating agent, the preferred concentration of the beta nucleating agent in the extruded polypropylene cast starting material is about 10 ppm, and perhaps less, up to about 100 ppm. When such levels of the beta nucleating pellet concentrate are added to the polypropylene batch, it has been found that up to 80% of the crystalline structure in the cast starting material after extrusion is in the beta crystalline form. Hence, the nucleating agent has converted more than a majority of the original alpha crystalline structure to the beta form. It is this beta crystalline formation that, when the cast starting material is then biaxially stretched into a finished oriented net, the result is higher strengths, higher torsional stiffness, increased modulus characteristics, and greater flexural stiffness for the finished lightweight net, and results in the significantly faster speeds for the orienting process.

It is believed that conversion of the polypropylene alpha crystals by the beta nucleating agent to as little as 20%-30% of the beta crystalline form in the final cast net can cause the resultant oriented net, stretched uniaxially or biaxially, to exhibit the improved property characteristics and processing enhancements described herein. However, higher conversion is clearly desirable in order to achieve the full benefits of the polypropylene beta crystalline structure. Therefore, the beta nucleating conversion should preferably result in a cast net after extrusion having up to 80%, or more, polypropylene in the beta crystalline form.

As an example, it is believed that a 24-lb/1,000 ft² (117 grams/square meter) lightweight oriented net can increase in strand strength in both directions by 15-20%, and increase in process orientation speed by 25%, by the addition of 2.0% of the beta nucleant polymer concentrate. This clearly is an economic advantage over the non-nucleated product.

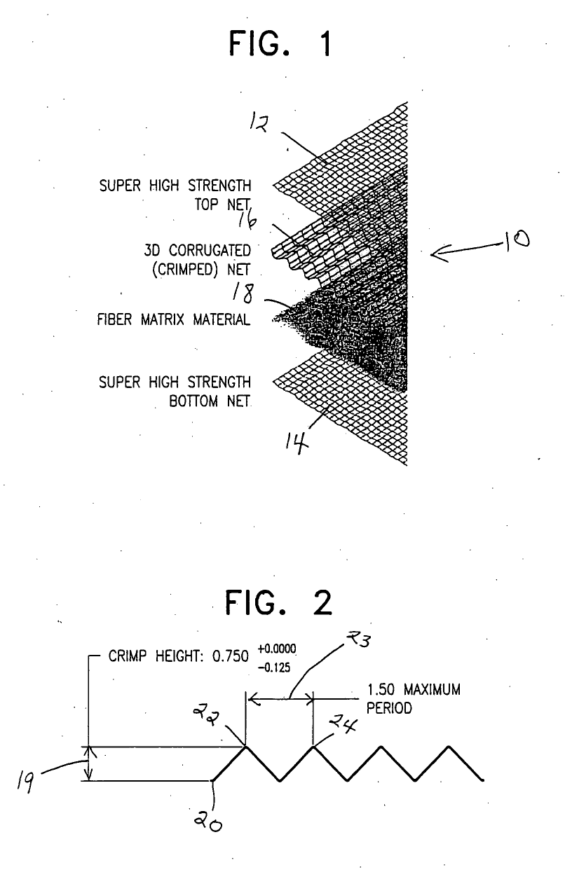

Turning now to the drawing figures, FIG. 1 illustrates a portion of a sandwich mat product constructed in accordance with the present invention and is generally designated by reference numeral 10. The sandwich mat product 10 includes a top layer of lightweight oriented net 12 and a bottom layer of a similar oriented net 14. Sandwiched between oriented net layers 12 and 14 are a corrugated or crimped oriented net 16 made in accordance with the present invention and a conventional fiber matrix material 18. Fiber matrix materials 18 are well known to those skilled in the art of mats for erosion control and any suitable fiber matrix material can be used in the sandwich mat product 10. The sandwich mat product 10 is especially useful for erosion control.

A schematic side view of the corrugated or crimped oriented net made in accordance with the present invention is illustrated in FIG. 2 and starts out as a generally flat oriented net, similar to the oriented nets 12 and 14. During the crimping process, the beta nucleated oriented net is reheated up to crimping temperature, processed through a crimper which shapes the net as shown in FIG. 2, and then passes through a cooling tank so that the crimped net retains its FIG. 2 shape. When the crimped net 16 exits the cooling tank, it preferably has a crimp height between opposite peaks, such as peaks 20 and 22 as shown by arrow 19, of about 0.750 inches +0.0000/−0.125 inches. The distance between adjacent peaks, such as peaks 22 and 24 as shown by arrow 23, is preferably no more than about 1.50 inches.

It is believed that the beta crystalline formation by adding a beta nucleant into the polypropylene polymer as described herein results in the improved crimping characteristics for the crimped oriented net of the present invention. More specifically, when the finished oriented net is subjected to the crimping heat process at high crimping temperatures (300° F.-450° F.) and then cooled, the crimped oriented net retains a higher crimp rigidity, higher crimp retention, and higher crimp resiliency, than the equivalent biaxial net without the beta nucleant additive. For example, conventional polypropylene oriented net (without the beta nucleated additive) will exhibit a crimp retention of about 80%-85%, i.e. when the crimped oriented net is crushed and the crushing pressure removed it recovers 80%-85% of its original height. A comparable crimped oriented net made of beta nucleated polypropylene in accordance with the present invention has a crimp retention in excess of 90%.

The foregoing is considered illustrative only as the principles of the invention. Further, since numerous modifications and changes will readily occur to those skilled in the art, it is not desired to limit the invention to the exact methods and structures shown and described and, accordingly, all suitable modifications and equivalents may be resorted to, falling within the scope of the invention.

1. An integral biaxially oriented polypropylene net, characterized in that said polypropylene net has a minium of 20% polypropylene in the beta crystalline form.

2. The integral polypropylene net of claim 1, characterized in that said polypropylene net has a minimum of 50% polypropylene in the beta crystalline form.

3. The integral polypropylene net of claim 1, characterized in that said polypropylene net has a concentration of a beta nucleant of about 10 ppm to about 100 ppm of said net.

4. The integral polypropylene net of claim 1, characterized in that said polypropylene net has a least 80% polypropylene in the beta crystalline form.

5. A method of making an integral polypropylene net by forming or casting polypropylene into a sheet like starting material having a defined pattern of holes or depressions and biaxially stretching said starting material to form a biaxially oriented net, characterized in that a beta nucleating agent is added to said polypropylene.

6. The method of claim 5, characterized in that said beta nucleating agent is a red quinacridone dye.

7. The method of claim 5, characterized in that said beta nucleating agent is present at a concentration of about 10 ppm to about 100 ppm.

8. The method of claim 5, characterized in that the beta nucleating agent is added in a concentrated form having about 450 ppm to about 2000 ppm of the beta nucleating agent in a polypropylene resin mixture.

9. The integral polymer net of claim 1, characterized in that said polypropylene net has increased tensile, torsional and flexural strength and crimping characteristics when compared to the same polypropylene net manufactured without addition of a beta nucleating agent.

10. A crimped biaxially oriented polypropylene net, characterized in that said polypropylene net has a minium of 20%, and preferably at least 80%, polypropylene in the beta crystalline form.

11. The integral polymer net of claim 1, characterized in that said polypropylene net has a concentration of a beta nucleant of about 10 ppm to about 100 ppm of said net.

12. A sandwich mat product for erosion control, characterized in that it includes as a layer the integral polymer grid of claim 10.

13. A sandwich mat product having an oriented polypropylene net upper layer and an oriented polypropylene net lower layer, which have sandwiched therebetween a fiber matrix material layer and a crimped polypropylene oriented net layer, characterized in that said crimped polypropylene net layer has a minimum of 20%, and preferable at least 80%, polypropylene in the beta crystalline form.

14. The integral polymer net of claim 3, characterized in that said beta nucleant is a red quinacridone dye.

15. The sandwich mat product of claim 13, characterized in that said crimped polypropylene oriented net layer has a concentration of beta nucleant of about 10 ppm to about 100 ppm of said net layer.
